(19) United States
(12) Patent Application Publication
(10) Pub. No.: US 2007/0007465 A1
(43) Pub. Date: Jan. 11, 2007

(54) Display apparatus

(76) Inventors: Hyun-yong Choi, Chuncheon-si (KR); Dae-Il Chung, Suwon-si (KR); Tai-hung Kim, Suwon-si (KR)

Correspondence Address: STANZIONE & KIM, LLP, 919 18TH STREET, N.W., SUITE 440, WASHINGTON, DC, 20006, US

(21) Appl. No.: 11/411,026

(22) Filed: Apr. 26, 2006

(30) Foreign Application Priority Data
Jul. 11, 2005 (KR) 2005-062111

(51) Int. Cl. H01J 27/00

(52) U.S. Cl. 250/423 R

(57) ABSTRACT

A display apparatus includes a casing having a negative ion emitting vent formed therein, a negative ion generator having an electrode provided in the casing corresponding to the negative ion emitting vent to generate negative ions, and a cleaner movably coupled to the casing to contact and clean the electrode. Accordingly, the display apparatus is capable of cleaning an electrode of a negative ion generator.

### CROSS-REFERENCE TO RELATED APPLICATIONS

This application claims priority from Korean Patent Application No. 2005-0062111, filed on Jul. 11, 2005, in the Korean Intellectual Property Office, the disclosure of which is incorporated herein by reference in its entirety.

### BACKGROUND OF THE INVENTION

1. Field of the Invention

The present general inventive concept relates to a display apparatus, and more particularly, to a display apparatus including a cleaner to clean an electrode of a negative ion generator.

2. Description of the Related Art

In general, a display apparatus includes a display main body, and a base placed on an installation surface such as a table to support the display main body. The display apparatus refers to any type of apparatus that forms images such as a television set or a monitor for use in a computer.

The display main body usually employs a flat display module such as an LCD (liquid crystal display) or a PDP (plasma display panel).

Recently, a display apparatus equipped with a negative ion generator that generates negative ions that are beneficial to the human body has been under development.

This display apparatus that is equipped with the negative ion generator is described in Japanese Patent First Publication No. 2004-24933. The display apparatus described therein is a conventional display apparatus including a negative ion generator provided in a casing to generate the negative ions, an on/off switch to turn the negative ion generator on/off, and a negative ion vent provided in the casing to allow the negative ions generated by the negative ion generator to flow out of the display apparatus. Therefore, the conventional display apparatus can supply a user with the negative ions by emitting the negative ions generated by the negative ion generator out of the display apparatus.

However, although the conventional display apparatus can generate the negative ions using an electrode of the negative ion generator, a negative ion generation efficiency of the electrode can be reduced due to an absence of a cleaning device for removing foreign matters attached to the electrode.

### SUMMARY OF THE INVENTION

Accordingly, the present general inventive concept provides a display apparatus capable of cleaning an electrode of a negative ion generator.

Additional aspects of the general inventive concept will be set forth in the description which follows, and in part will be apparent from the description, or may be learned by practice of the general inventive concept.

The foregoing and/or other aspects of the present general inventive concept are achieved by providing a display apparatus, comprising a casing having a negative ion emitting vent formed therein, a negative ion generator having an electrode provided in the casing corresponding to the negative ion emitting vent to generate negative ions, and a cleaner movably coupled to the casing to contact and clean the electrode.

The cleaner may comprise a brush provided to contact the electrode, and a knob movably provided in one body with the brush in the casing to protrude outside of the casing, and the casing has a knob accommodating part through which the knob protrudes outside of the casing.

The cleaner may further comprise a support member extending from the knob to support a movement of the knob.

The support member may be made of an elastic material to provide a predetermined elastic force when the knob is moved inside of the casing through the knob accommodating part.

The knob accommodating part may be formed to be greater in size than the knob such that the knob can be moved in a horizontal direction with respect to an accommodating direction of the knob accommodating part. The casing may include guide parts provided therein to guide the support member in the horizontal direction with respect to the accommodating direction of the knob accommodating part.

The guide parts may be provided near opposite sides of the knob to receive and support the support member.

The negative ion emitting vent may be provided in a front lower portion of the casing, and the knob accommodating part may be formed in a bottom portion of the casing such that the cleaner is disposed below the electrode.

The negative ion generator may include a circuit part connected to the electrode to control the electrode to generate the negative ions and a ground part spaced apart from the electrode.

The circuit part may include a circuit casing to house a drive circuit and an electrode support part provided at the circuit casing to support the electrode.

The display apparatus may further comprise a negative ion light emitting diode connected to the circuit part to emit light when the negative ion generator generates the negative ions, and a block bracket to prevent the light emitted from the negative ion light emitting diode from leaking sideways. The ground part may be provided at the block bracket.

The foregoing and/or other aspects of the present general inventive concept are also achieved by providing a display apparatus, comprising a display module to display one or more images, a casing to surround the display module, an ion generator disposed in the casing to generate ions and to emit the ions from the casing, and a cleaner having a cleaning portion extending from the casing inward toward the ion generator and a knob portion extending from the casing outward and being movable with respect to the casing.

The foregoing and/or other aspects of the present general inventive concept are also achieved by providing a display apparatus, comprising a casing having an ion vent and an LED hole disposed adjacent to the ion vent, an ion generator disposed in the casing to emit ions out of the casing via the ion vent, an LED disposed in the casing adjacent to the ion generator to emit light out of the casing via the LED hole, and a block bracket disposed between the LED and the ion generator to block the light emitted by the LED from being emitted from the ion vent.

The foregoing and/or other aspects of the present general inventive concept are also achieved by providing a display apparatus, comprising a housing, an electrode disposed inside the housing to generate a discharge, and a movable knob extending from the housing and having a cleaning portion disposed inside the housing to clean the electrode according to a movement of the knob.

The foregoing and/or other aspects of the present general inventive concept are also achieved by providing a cleaner usable with a display apparatus having a casing and an ion generator disposed in the casing, the cleaner comprising a support part to be coupled with an opening in the casing, a cleaning portion extending from the support part into the casing toward the ion generator, and a movement control portion extending from an opposite side of the support part out of the casing and being movable to move the cleaning portion with respect to the casing.

It is to be understood that both the foregoing general description and the following detailed description are exemplary and explanatory and are intended to provide further explanation of the general inventive concept as claimed.

### BRIEF DESCRIPTION OF THE DRAWINGS

These and/or other aspects of the present general inventive concept will become apparent and more readily appreciated from the following description of the embodiments, taken in conjunction with the accompany drawings, in which:

FIG. 1 is a perspective view illustrating a display apparatus according to an embodiment of the present general inventive concept;

FIG. 2 illustrates a rear perspective view of a front casing equipped with a negative ion generator and a cleaner of the display apparatus of FIG. 1;

FIG. 3 illustrates an exploded perspective view of the negative ion generator and the cleaner of the display apparatus of FIG. 1; and

FIGS. 4 and 5 are partial front perspective views illustrating an operation of the cleaner of the display apparatus of FIG. 1, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

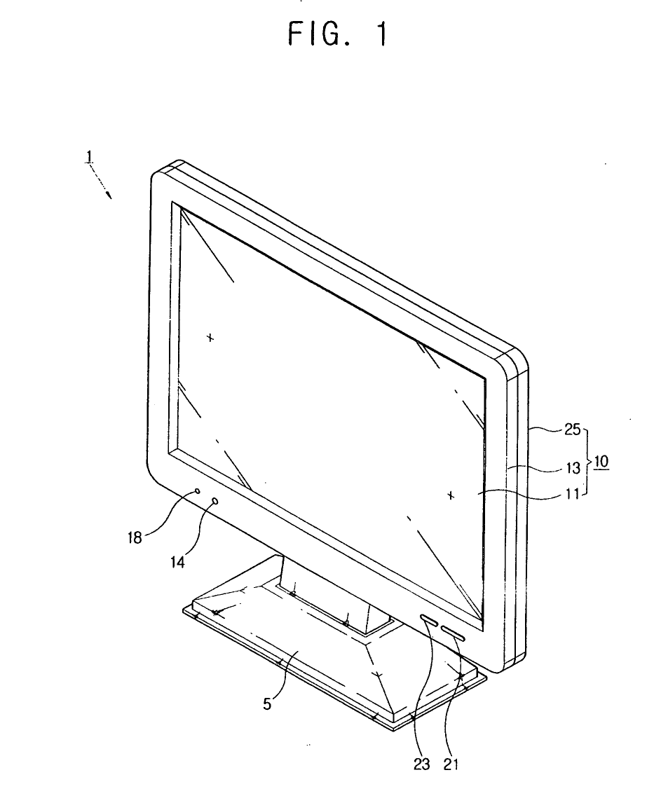

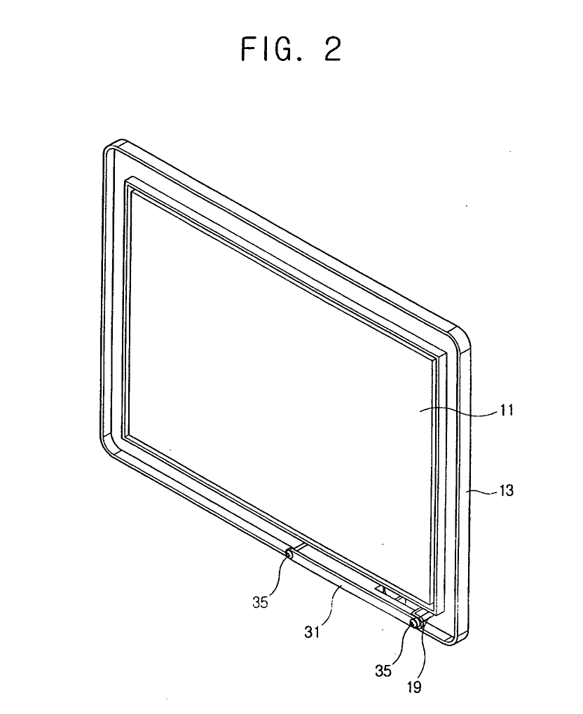

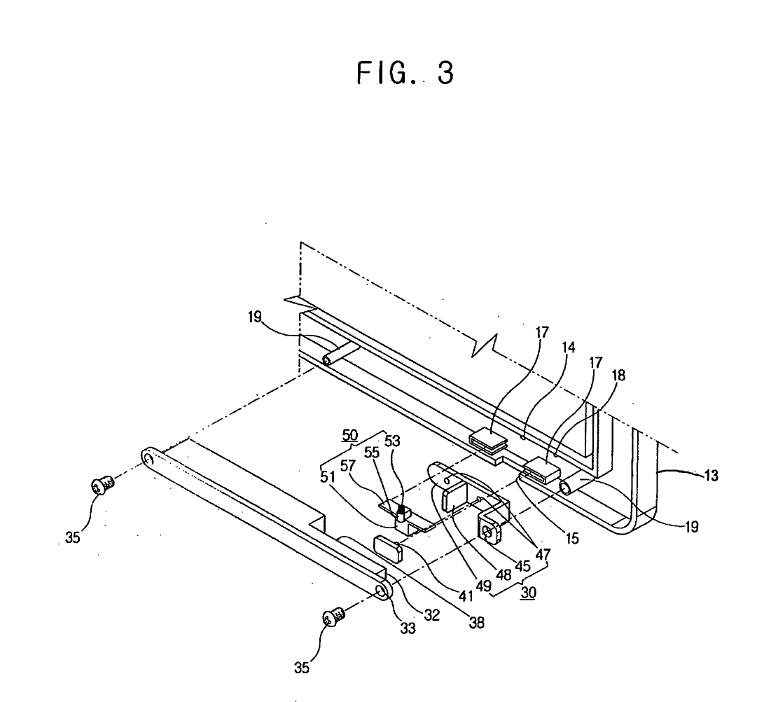

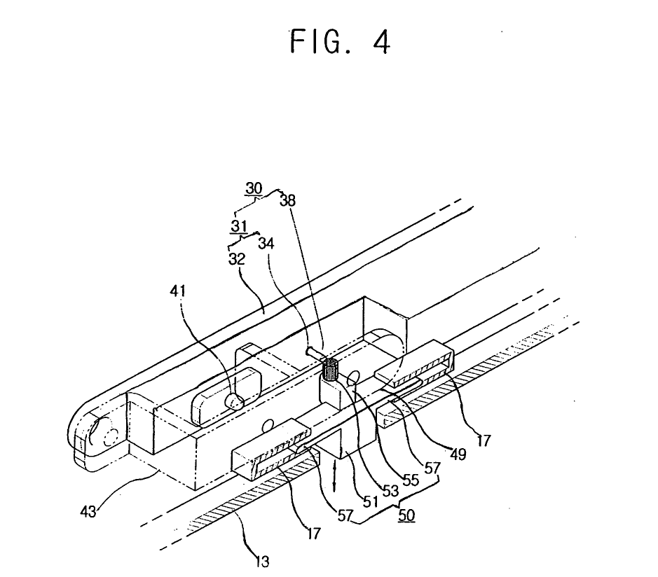

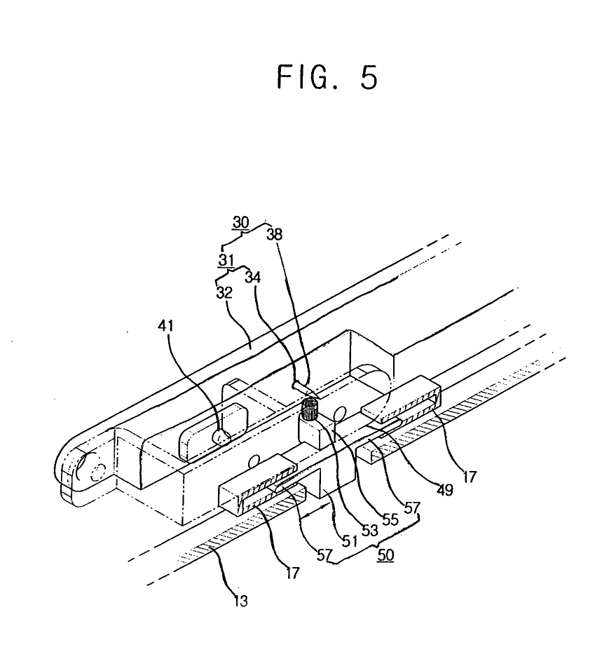

FIG. 1 is a perspective view illustrating a display apparatus 1 according to an embodiment of the present general inventive concept. FIG. 2 illustrates a rear perspective view of a front casing 13 equipped with a negative ion generator 30 and a cleaner 50 of the display apparatus 1 of FIG. 1. FIG. 3 illustrates an exploded perspective view of the negative ion generator 30 and the cleaner 50 of the display apparatus 1 of FIG. 1. FIGS. 4 and 5 are partial front perspective views illustrating an operation of the cleaner 50 of the display apparatus 1 of FIG. 1, according to an embodiment of the present general inventive concept.

As illustrated in FIGS. 1 to 4, the display apparatus 1 includes a display main body 10 to display images, a base 5 to support the display main body 10 on an installation surface, a negative ion generator 30 provided in the display main body 10 and having an electrode 38 to generate negative ions, and a cleaner 50 movably coupled with the display main body 10 so as to contact and clean the electrode 38.

Referring to FIG. 1, the display main body 10 has a display module 11 on which the images are formed, a casing including the front casing 13 and a rear casing 25 provided around an outer periphery of the display module 11 to define an outer appearance thereof, and a drive circuit part 31 (see FIGS. 2, 4, and 5) provided in the front and rear casings 13 and 25 to drive the display module 11.

The display module 11 may include, for example, an LCD (liquid crystal display), a PDP (plasma display panel), a cathode ray tube, or the like.

Referring to FIGS. 1 to 5, a negative ion vent 14 is perforated in a front portion of the front casing 13 toward the electrode 38, and an LED hole 18 is perforated in the front portion of the front casing 13 toward a negative ion LED 41 (to be described later). A knob accommodating part 15 is provided in a bottom portion of the front casing 13 to allow a knob 51 of the cleaner 50 (to be described later) to be inserted into the bottom portion of the front casing 13. Guide parts 17 to guide a support member 57 (to be described later) of the cleaner 50, and a plurality of combining bosses 19 to which both a circuit part 31 (described later) and a block bracket 43 are fixed by screws 35 are provided on an inner surface of the front casing 13. The guide parts 17 are disposed adjacent to the knob accommodating part 15. An on/off switch 21 to turn the display module 11 on/off and a negative ion switch 23 to turn the negative ion generator 30 on/off may be provided in the front casing 13. Although the embodiments of the present general inventive concept describe the screws 35 to fix the block bracket 43 and the circuit part 31 to the front casing 13, it should be understood that other types of fasteners may alternatively be used. Additionally, the block bracket 43 and the circuit part 31 may be secured to the rear casing 25, instead of the front casing 13.

In an exemplary embodiment of the present general inventive concept, the negative ion vent 14 is formed at a front lower portion of the front casing 13. Thus, the negative ions generated by the electrode 38 can be transmitted to a user in front of the display apparatus 1 through the negative ion vent 14. Alternatively, the negative ion vent 14 may be provided in an upper portion of the front casing 13, a side portion of the front casing 13, or in the rear casing 25 according to a position of the electrode 38 within the main body 10 of the display apparatus 1. Although the negative ion vent 14 is formed to have a circular shape in the present embodiment, it should be understood that the negative ion vent 14 may be formed to have a variety of other shapes including, for example, an ellipse, a rectangle, or other shapes.

The LED hole 18 may be provided beside the negative ion vent 14 to allow light generated from the negative ion LED 41 to be emitted forward from the front casing 13. The LED hole 18 may be provided at any portion of the front casing 13 that corresponds to the position of the negative ion LED 41.

The knob accommodating part 15 may be formed in the bottom portion of the front casing 13 in a top-bottom direction to accommodate the knob 51 such that the knob 51 extends downward from the front casing 13. The knob accommodating part 15 is formed to have a size that is greater than that of the knob 51 such that the knob 51 can be moved in a horizontal direction with respect to an accommodating direction of the knob accommodating part 15. That is, since the knob accommodating part 15 may be formed in the bottom portion of the front casing 13 in the top-bottom direction, the knob 51 can be moved by a predetermined distance in a left-right direction. The size of the knob accommodating part 15 is large enough such that an extent that a brush 53 of the cleaner 50 contacts and cleans the electrode 38 when the knob 51 is moved in the left-right direction. However, it should be understood that the knob accommodating part 15 may be provided at any portion of the front casing 13 or the rear casing 25 according to the position of the electrode 38 within the main body 10 of the display apparatus 1.

The guide parts 17 may be provided at the front casing 13 in the horizontal direction with respect to the accommodating direction of the knob accommodating part 15 to guide the support member 57 of the cleaner 50. The guide parts 17 may be provided adjacent to opposite sides of the knob accommodating part 15 to correspond to the support member 57 to receive and guide the support member 57.

The negative ion generator 30 includes the electrode 38, the circuit part 31 connected to the electrode 38 to control the electrode 38 to generate the negative ions, and a ground part 49 spaced apart from the electrode 38. The negative ion generator 30 may further include the negative ion LED 41 which is connected to the circuit part 31 and emits light when the electrode 38 generates the negative ions, and the block bracket 43 to prevent the light emitted from the negative ion LED 41 from leaking sideways.

The circuit part 31 includes a circuit casing 32 to house a drive circuit (not shown) and an electrode support part 34 provided at the circuit casing 32 to support the electrode 38. The circuit part 31 is connected to the negative ion switch 23, and thus supplies power to the electrode 38 when the negative ion switch 23 is turned on. However, it should be understood that when the negative ion switch 23 is not provided separately from the on/off switch 21, the circuit part 31 can be supplied with power when the on/off switch 21 is turned on.

The drive circuit connected to the electrode 38 to supply predetermined power thereto is housed in the circuit casing 32. The drive circuit may generate a voltage of about 4000V and apply the voltage of 4000V to the electrode 38. However, it should be understood that the drive circuit is not limited to applying the voltage of about 4000V, and may generate voltages of a variety of values, such as about 1000 to 10000V. The circuit casing 32 completely seals the drive circuit that generates a high voltage that corresponds to the predetermined power. Therefore, contact with the drive circuit and undesired radiation of electromagnetic waves generated from the drive circuit can be prevented by the circuit casing 32. The negative ion LED 41 may be provided at the circuit casing 32 to be connected to the driving circuit, and thus emits light when the electrode 38 generates the negative ions. The circuit casing 32 is provided with circuit casing combining parts 33 to be combined with the combining bosses 19 by the screws 35.

The electrode 38 is coupled with the electrode support part 34 so as to be connected to the driving circuit. The electrode 38 can be coupled with the electrode support part 34 by inserting a first end portion thereof into the electrode support part 34, or by inserting the first end portion thereof into the electrode support part 34 and then applying an adhesive thereto. The electrode 38 and the electrode support part 34 are coupled at least to an extent that the electrode 38 is not separated from the electrode support part 34 when the electrode 38 is cleaned by the cleaner 50. A second end portion of the electrode 38 generates the negative ions by discharge with the ground part 49. The second end portion of the electrode 38 has a pointed shape that extends forward. Foreign matters, such as dust, introduced through the negative ion vent 14 provided in the front casing 13 can be attached to the electrode 38, and thus a negative ion generation efficiency of the electrode 38 can be reduced by the foreign matters attached to the electrode 38.

The ground part 49 is spaced apart from the electrode 38 by a predetermined distance such that the discharge can be generated therebetween. The ground part 49 may be formed in one body with the block bracket 43. That is, the ground part 49 can be formed by making a side portion of the block bracket 43 with a conductive material. For example, the ground part 49 may be formed by coating the conductive material on the block bracket 43 or by attaching a separate conductive part to the block bracket 43.

The block bracket 43 is plate-shaped, and has a bracket combining part 45 to be combined to the combining boss 19 in the front casing 13 with the circuit casing 32 by the screws 35. The block bracket 43 has a block part 48 to prevent the light emitted from the negative ion LED 41 from leaking through the negative ion vent 14. The ground part 49 made of the conductive material is provided adjacent to the electrode 38 on the block bracket 43. A pair of perforation parts 47 are perforated in the block bracket 43 to correspond to the negative ion vent 14 and the LED hole 18.

The block part 48 extends backwards and is disposed between the pair of perforation parts 47 to prevent the light emitted from the negative ion LED 41 from leaking to the negative ion vent 14.

The cleaner 50 is movably coupled to the front casing 13 to be in contact with the electrode 38 and to remove the foreign matters attached to the electrode 38. The cleaner 50 has a brush 53 that contacts the electrode 38, and the knob 51 formed in one body with the brush 53 movably provided in the front and rear casings 13 and 25 to protrude outward from the front casing 13. The knob 51 may extend downward from the main body 10. The cleaner 50 further includes the support member 57 extending from the knob 51 to support the movement of the knob 51. The cleaner 50 is disposed below and near the electrode 38. The knob 51 is exposed outside of the front casing 13 through the knob accommodating part 15 of the front casing 13. Accordingly, a user can touch and move the knob 51.

The brush 53 is supported by a brush support part 55 provided between the knob 51 and the brush 53. The brush 53 is moved in one body with the knob 51 while contacting the electrode 38, so that the brush 53 can remove the foreign matters attached to the electrode 38.

The support member 57 is formed of an elastic material, such as rubber or plastic, to provide a predetermined elastic force when the knob 51 is moved in the knob accommodating part 15. The support member 57 is provided in a pair arrangement at opposite sides of the knob 51. However, the support member 57 may be provided in a singular arrangement at the one side of the knob 51, or may include more than two parts. The support member 57 is received in the guide parts 17 to be movable in the horizontal direction with respect to the accommodating direction of the knob accommodating part 15. That is, the support member 57 is made of the elastic material so that the support member 57 can be moved in the accommodating direction of the knob accommodating part 15 (i.e., the top-bottom direction) and can be moved in the horizontal direction with respect to the accommodating direction of the knob accommodating part 15 (i.e., left-right direction) while being guided by the guide parts 17. Accordingly, the user can clean the electrode 38 by pressing the knob 51 upward several times to contact the electrode 38 repeatedly, and by moving the knob 51 left and right several times to bring the brush 53 into contact therewith repeatedly.

Operation of the cleaner 50 of the display apparatus 1 according to an embodiment of the present general inventive concept will now be described.

First, by turning on the negative ion switch 23, the negative ion generator 30 is operated. Then, the circuit part 31 applies the predetermined power to the electrode 38, and thus the negative ions are generated by the discharge between the electrode 38 and the ground part 49. The negative ions are emitted outside of the front and rear casings 13 and 25 through the negative ion vent 14 by a natural convection current, or the like. After an extended period of use, the foreign matters, such as dust, may be introduced to the front and rear casings 13 and 15 through the negative ion vent 14 and may be attached to the electrode 38. In this case, after turning off the negative ion switch 23, the user can push the knob 51, which extends through the knob accommodating part 15, upward to bring the brush 53 into contact with the electrode 38. The user can move the knob 51, which is exposed through the knob accommodating part 15, left and right to bring the brush 53 into contact with the electrode 38, repeatedly. The knob 51 may be any type of movable protrusion (e.g., a movement control portion) extending from the one or more of the front and rear casings 13 and 25.

As described above, the display apparatus 1 according to the present embodiment is capable of preventing a reduction in the negative ion generation efficiency of the electrode 38, since the user can readily remove the foreign matters attached to the electrode 38 by moving the knob 51.

In accordance with the embodiments of present general inventive concept, it is possible to provide a display apparatus capable of preventing a reduction in the negative ion generation of the electrode by readily removing the foreign matters attached to the electrode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus, comprising:
a casing having a negative ion emitting vent formed therein;
a negative ion generator having an electrode provided in the casing corresponding to the negative ion emitting vent to generate negative ions; and
a cleaner movably coupled to the casing to contact and clean the electrode.

2. The display apparatus according to claim 1, wherein the cleaner comprises:
a brush to contact the electrode; and
a knob movably provided in one body with the brush in the casing to protrude outside of the casing,
wherein the casing has a knob accommodating part through which the knob extends outside of the casing.

3. The display apparatus according to claim 2, wherein the cleaner further comprises a support member extending from the knob to support a movement of the knob.

4. The display apparatus according to claim 3, wherein the support member is made of an elastic material to provide a predetermined elastic force when the knob is moved inside of the casing through the knob accommodating part.

5. The display apparatus according to claim 3, wherein the knob accommodating part is formed to be greater in size than the knob such that the knob can be moved in a horizontal direction with respect to an accommodating direction of the knob accommodating part, and the casing includes guide parts provided therein to guide the support member in the horizontal direction with respect to the accommodating direction of the knob accommodating part.

6. The display apparatus according to claim 4, wherein the knob accommodating part is formed to be greater in size than the knob such that the knob can be moved in a horizontal direction with respect to an accommodating direction of the knob accommodating part, and the casing includes guide parts provided therein to guide the support member in the horizontal direction with respect to the accommodating direction of the knob accommodating part.

7. The display apparatus according to claim 5, wherein the guide parts are provided near opposite sides of the knob to receive and support the support member.

8. The display apparatus according to claim 6, wherein the guide parts are provided near opposite sides of the knob to receive and support the support member.

9. The display apparatus according to claim 7, wherein the negative ion emitting vent is provided in a front lower portion of the casing, and the knob accommodating part is formed in a bottom portion of the casing such that the cleaner is disposed below the electrode.

10. The display apparatus according to claim 8, wherein the negative ion emitting vent is provided in a front lower portion of the casing, and the knob accommodating part is formed in a bottom portion of the casing such that the cleaner is disposed below the electrode.

11. The display apparatus according to claim 1, wherein the negative ion generator has a circuit part connected to the electrode to control the electrode to generate the negative ions and a ground part spaced apart from the electrode.

12. The display apparatus according to claim 11, wherein the circuit part has a circuit casing to house a drive circuit and an electrode support part provided at the circuit casing to support the electrode.

13. The display apparatus according to claim 11, further comprising:
a negative ion light emitting diode connected to the circuit part to emit light when the negative ion generator generates the negative ions; and
a block bracket to prevent the light emitted from the negative ion light emitting diode from leaking sideways,
wherein the ground part is provided at the block bracket.

14. A display apparatus, comprising:
a display module to display one or more images;
a casing to surround the display module;
an ion generator disposed in the casing to generate ions and to emit the ions from the casing; and
a cleaner having a cleaning portion extending from the casing inward toward the ion generator and a knob portion extending from the casing outward and being movable with respect to the casing.

15. The display apparatus according to claim 14, wherein the knob portion is movable along two directional axes.

16. The display apparatus according to claim 14, wherein the cleaner is disposed in a bottom portion of the casing such that the clean portion extends upward from underneath the ion generator and the knob portion extends downward from the bottom of the casing.

17. The display apparatus according to claim 14, wherein the cleaning portion comprises a brush having a plurality of bristles.

18. The display apparatus according to claim 14, wherein the ion generator comprises:
an electrode to emit negative ions; and
an ion vent disposed in a portion of the casing in front of the electrode to allow the negative ions to be supplied out of the casing.

19. The display apparatus according to claim 18, wherein the ion generator further comprises:
a ground part opposite the electrode to cause the electrode to discharge when a voltage is applied thereto such that the negative ions are emitted as a result of the discharge.

20. The display apparatus according to claim 18, wherein the electrode has a pointed shape that extends toward the ion vent.

21. The display apparatus according to claim 14, wherein the cleaner comprises:
a guide part disposed inside the casing and having one or more slots extending parallel to the casing; and
a support part extending perpendicular to the cleaning and knob portions to be coupled with the one or more slots of the guide part to be supported in the casing.

22. The display apparatus according to claim 21, wherein at least one of the guide part and the support part is made of an elastic material to allow the knob portion to be move around the casing.

23. The display apparatus according to claim 14, further comprising:
a light emitting diode disposed adjacent to the ion generator in the casing to emit light; and
a block bracket disposed adjacent to the light emitting diode to block the light from the ion generator.

24. The display apparatus according to claim 14, further comprising:
an accommodating part to accommodate the cleaner and having a size that is larger than the cleaner such that the cleaner is movable within the accommodating part.

25. A display apparatus, comprising:
a casing having an ion vent and an LED hole disposed adjacent to the ion vent;
an ion generator disposed in the casing to emit ions out of the casing via the ion vent;
an LED disposed in the casing adjacent to the ion generator to emit light out of the casing via the LED hole; and
a block bracket disposed between the LED and the ion generator to block the light emitted by the LED from being emitted from the ion vent.

26. The display apparatus according to claim 25, wherein:
the ion generator comprises an electrode disposed in the casing and extending toward the ion vent; and
the block bracket comprises a blocking portion extending between the LED and the electrode and a ground part portion extending perpendicularly to the blocking portion and in front of the electrode.

27. The display apparatus according to claim 26, wherein the ground part comprises an opening that corresponds to the electrode.

28. A display apparatus, comprising:
a housing;
an electrode disposed inside the housing to generate a discharge; and
a movable knob extending from the housing and having a cleaning portion disposed inside the housing to clean the electrode according to a movement of the knob.

29. A cleaner usable with a display apparatus having a casing and an ion generator disposed in the casing, the cleaner comprising:
a support part to be coupled with an opening in the casing;
a cleaning portion extending from the support part into the casing toward the ion generator; and
a movement control portion extending from an opposite side of the support part out of the casing and being movable to move the cleaning portion with respect to the casing.

30. The cleaner according to claim 29, wherein the cleaning portion and the movement control portion extend in opposite directions from the support part.
